(19) United States
(12) Patent Application Publication
(10) Pub. No.: US 2025/0263977 A1
(43) Pub. Date: Aug. 21, 2025

(54) HIDDEN INSECT SCREEN FOR SLIDING WINDOWS

(71) Applicants: Andreea Vintila, Loxahatchee, FL (US); Vasile Vintila, Loxahatchee, FL (US)

(72) Inventors: Andreea Vintila, Loxahatchee, FL (US); Vasile Vintila, Loxahatchee, FL (US)

(21) Appl. No.: 18/444,733

(22) Filed: Feb. 18, 2024

(51) Int. Cl. E06B 9/54

(52) U.S. Cl. CPC E06B 9/54

(57) ABSTRACT

This concept addresses the redundancy of an insect screen while not in use and consists of a retractable insect screen connected in such way to the moving edge of a sliding window so that, when the window is opened—the screen gets pulled out to completely cover the window opening and, when the window is closed—the screen retracts inside its housing.

This concept consists of a retractable insect screen working in conjunction with a sliding window.

The leading edge of the screen is connected to the moving edge of the sliding window and the screen housing is affixed to the window frame.

The purpose of this concept is to keep the insect screen out of view when the window is closed, thus preserving the view of the outdoors, keeping the screen clean for longer and extending its service life.

The retractable screen can be incorporated into the window assembly during production or it can be added afterwards as a cut-to-fit application.

### DRAWINGS

FIG. 1—Screen_installed represents a general view of the way the screen is installed on a vertical sliding window.

FIG. 2—Screen_housing_with_end_covers represents the main components of the retractable screen assembled together.

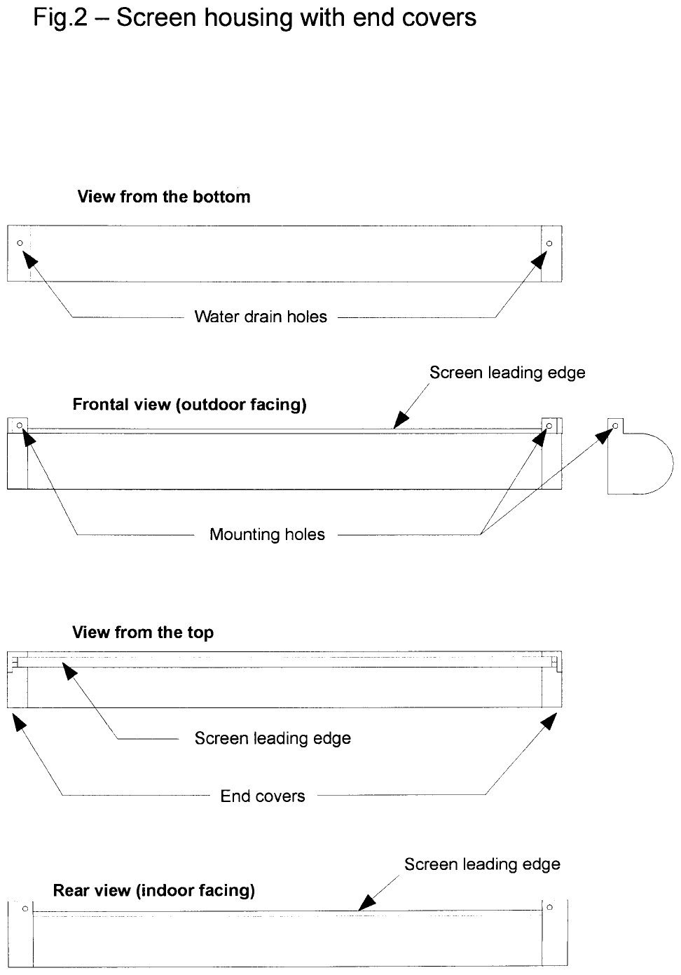

FIG. 3—Housing-to-cover shows the general way the screen housing matches in shape with the end cover, so that they can be assembled together.

FIG. 4—Screen-to-guide shows the general way the retractable screen assembly is positioned in relation to the screen guides.

FIG. 5—Screen-to-window shows the general way the screen leading edge can be connected to the moving edge of the sliding window.

### DESCRIPTION AND OPERATION

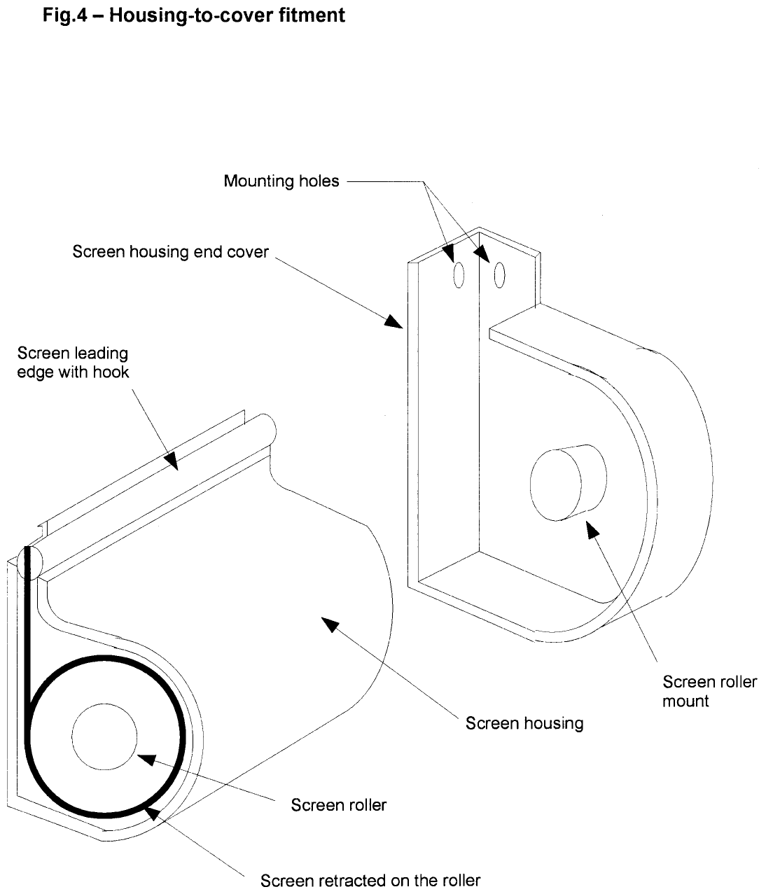

The insect screen will retract inside the housing using a clock-spring retraction mechanism located inside one of the end covers. One end of the clock-spring connects to the roller and the other end connects to the end cover. The end cover containing the retraction mechanism serves as an axle for the screen roller. The opposite (regular) end cover also serves as an axle for the screen roller (FIG. 4).

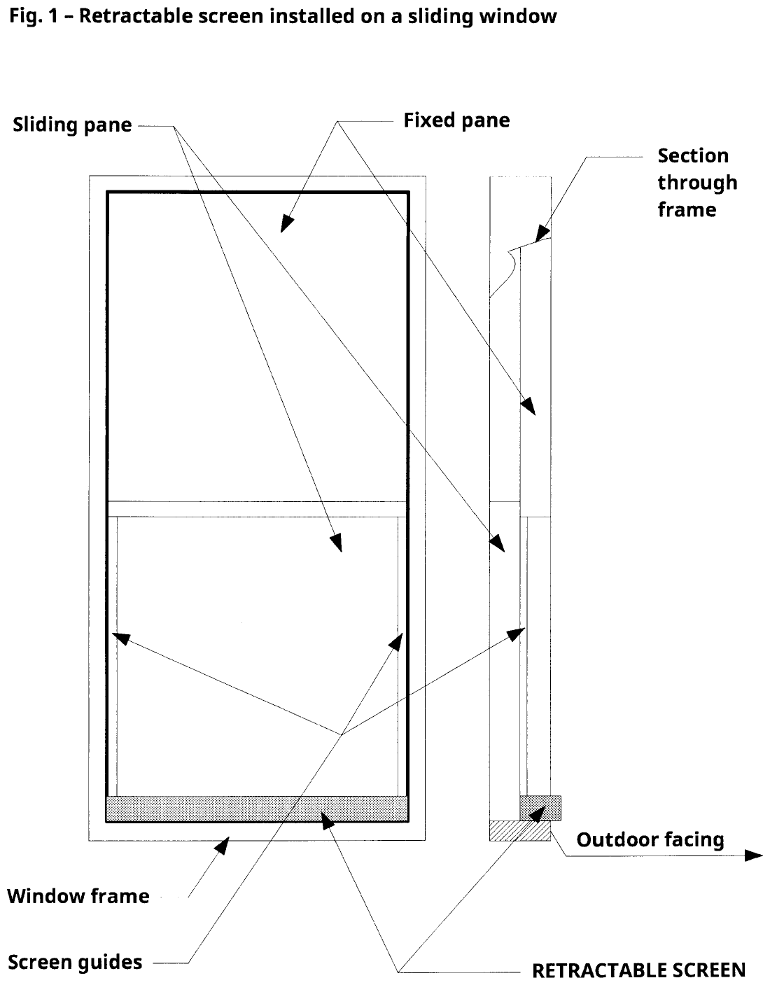

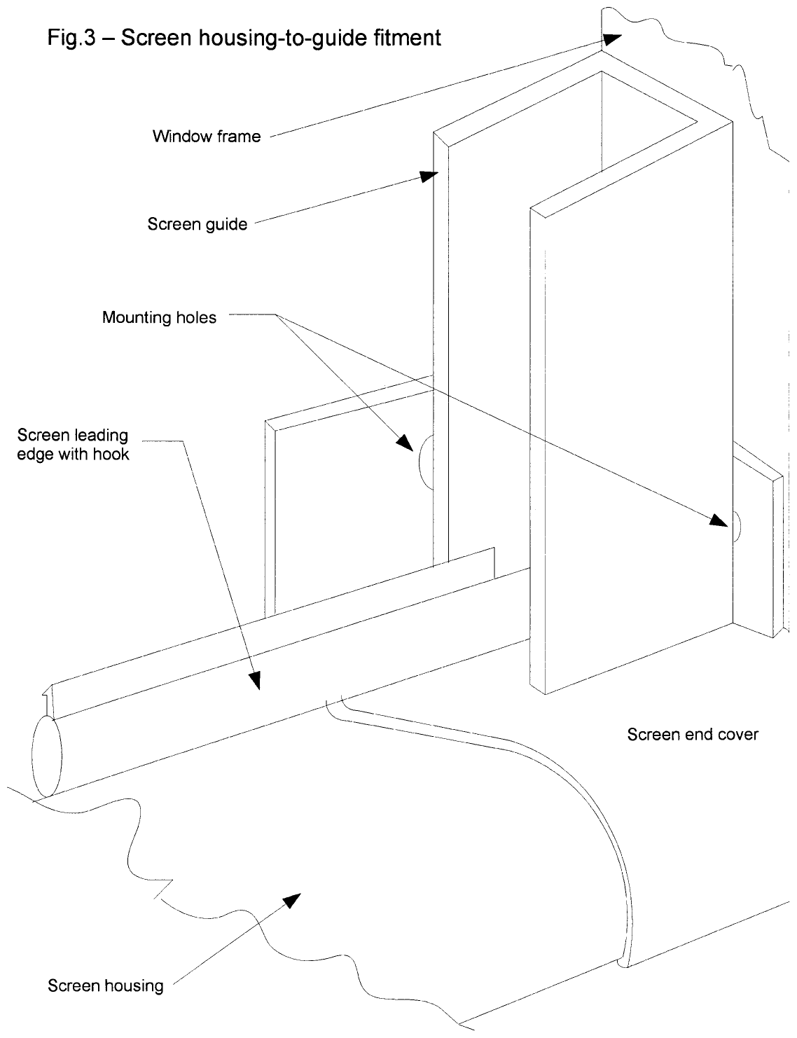

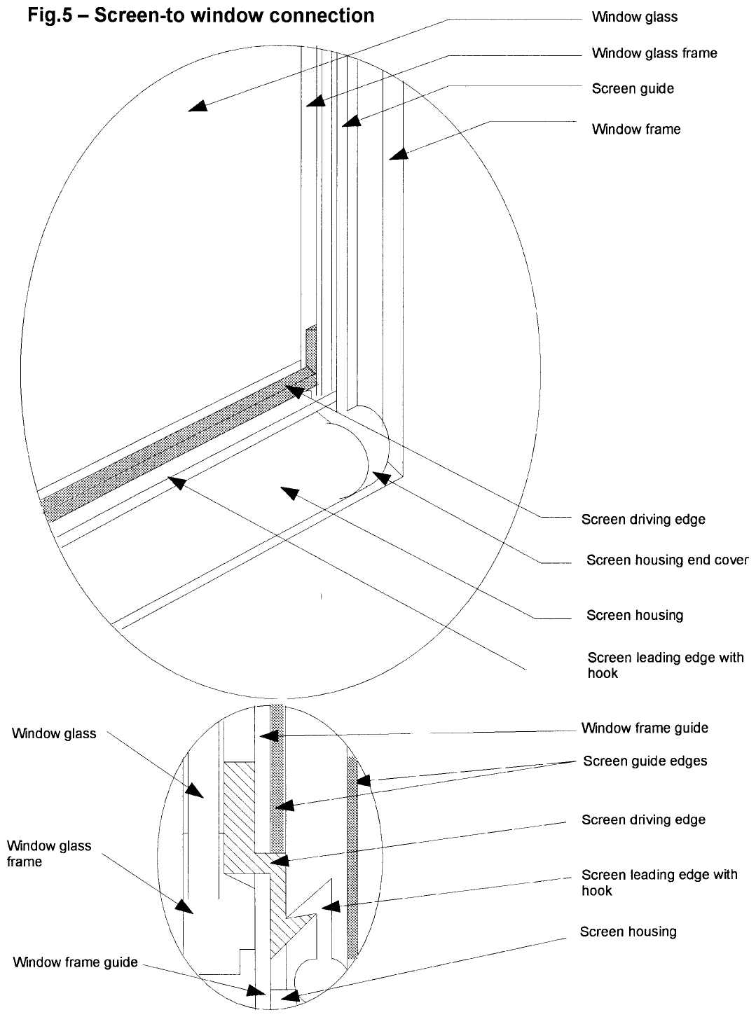

The leading edge of the screen is attached to the moving edge of the sliding window and will slide along two guides during operation, each located at either side of the window (FIG. 1, FIG. 3, FIG. 5). The opposite end of the screen is attached to the screen roller.

The leading edge connects to the sliding window by means of a corresponding driving edge inserted between the sliding window pane and the window guide (FIG. 5).

The screen guides can be attached to the window frame by using double-sided adhesive tape, clips or screws when possible.

The screen roller is installed inside the screen housing and supported by the two end covers. The screen housing is tightly secured to the window frame by means of screws installed in the mounting holes (FIG. 4), or other means.

When the sliding widow is opened, it will pull on the screen leading edge which in turn will pull the screen out of the housing.

The screen leading edge will slide along both guides, causing the screen to cover the window opening.

As the screen gets pulled out of the housing, it will turn the screen roller. While turning, the screen roller will rotate on its axles and will pull on the end of the clock-spring, causing it to wind up and accumulate tension.

The tension accumulated in the clock-spring needs to be lower that the force needed to close the window, so that the window can stay open and keep the screen extended.

When the window is closing, the tension accumulated in the clock-spring will turn the roller and the screen will roll back into the screen housing.

When the window is completely closed, the screen leading edge will rest flush against the screen housing, preventing dirt and debris ingress.

Each end cover has a drain hole at the bottom, to allow water to drain out of the screen housing.

The end of the screen housing covered by the regular cover will be used for cut-to-fit applications. With the screen retracted, the regular end cover will be removed, the cut-to-fit step will be performed and the regular end cover will be re-installed. This will assure the cutting of the screen leading edge to the proper size as well.

The leading edge will have a hook-like longitudinal ridge which engages with the corresponding ridge of the driving edge (FIG. 5).

The longitudinal ridge of the leading edge will be trimmed at both ends in order to stay clear of the screen guides.

The driving edge will be trimmed at both ends to fit between the sliding window pane and the window guides.

1. The hidden insect screen works in conjunction with a sliding window in such manner as, when the window is opened—the screen extends to cover the window opening and, when the window is closed—the screen retracts inside its housing, thus staying out of view, protected and with an extended lifespan.

2. The hidden retractable screen can be integrated with the window assembly during the manufacturing process or can be installed afterwards as a cut-to-fit application, case in which it will contain the necessary means to be installed securely on the window frame.

3. The hidden retractable screen is connected to the sliding window in such a manner as to allow it to be disconnected when needed.
